(19) United States
(12) Patent Application Publication
(10) Pub. No.: US 2013/0198324 A1
(43) Pub. Date: Aug. 1, 2013

(54) Systems and Methods For Managing Interconnection and Service Aspects Of External Connections To A Central Network

(71) Applicants: Brett Scorza, Plainfield, IL (US); Rosemary Hackett, Chicago, IL (US)

(72) Inventors: Brett Scorza, Plainfield, IL (US); Rosemary Hackett, Chicago, IL (US)

(73) Assignee: Neutral Tandem, Inc. d/b/a Inteliquent, Chicago, IL (US)

(21) Appl. No.: 13/593,025

(22) Filed: Aug. 23, 2012

Related U.S. Application Data
(60) Provisional application No. 61/593,723, filed on Feb. 1, 2012.

(51) Int. Cl. G06F 15/16

(52) U.S. Cl. 709/217

(57) ABSTRACT

A system for managing interconnection and service aspects amongst a plurality of external elements. According to a particular aspect, the system includes a server in communication with a central service network wherein the server hosts a portal application accessible to manage interconnection and service aspects amongst a plurality of external elements. The portal application has visibility of the edge connection points and connected external elements to determine interconnection and service aspects for one or more selected external elements.

### CROSS REFERENCE

This application claims the benefit of U.S. Provisional Patent Application No. 61/593,723 filed on Feb. 1, 2012, which is incorporated by reference herein in its entirety.

### TECHNICAL FIELD

This disclosure relates to the field of telecommunications, and more particularly to automation and management of interconnection and service aspects of external connections to a central network, such as, for example, automation and management via a portal application associated with the central network, which may comprise, for example, one or more Ethernet networks.

### BACKGROUND

Establishing and managing connectivity between various network types and locations with existing systems and methods can be an arduous and cumbersome task, and has much inherent inefficiency. This is particularly true in utilizing an Ethernet network platform to facilitate management and connectivity across various disparate network types and platforms, including, but not limited to, traditional telephony and service networks and installations. The invention(s) described herein is/are directed but not limited to addressing problems associated with these existing systems and methods, and in a particular embodiment, a portal application is leveraged to address such problems. While portals that manage a single telecommunications network exist, no system exists that, for example, facilitates the automated management and connectivity across various disparate network types and platforms.

### SUMMARY

A system for managing interconnection and service aspects amongst a plurality of external elements is provided. According to a particular aspect, the system includes a server in communication with a central service network and hosting a portal application accessible to manage interconnection and service aspects amongst the plurality of external elements. By way of example, the external elements may be a corporate network, a service provider network, a carrier network, an application service server (e.g., a cloud computing service server, a videoconferencing service server, etc.), a device, a corporate end user location, or a multi-tenant location. The central service network includes a plurality of edge connection points in communication with each other and each either in communication with or capable of communicating with at least one of the plurality of external elements. The portal application has visibility of the edge connection points and connected external elements to determine interconnection and service aspects for one or more selected external elements. By way of example, the interconnection and service aspects may include the immediate identification of connectability to the selected external elements, quality of service (QoS), service offerings, capabilities, connection type, or statistics for the selected external elements.

According to other aspects, the portal application provides to users, customers and potential subscribers the ability to manage the selection, connection and provisioning of services, such as application services or data or voice connection services, based on various criteria, such as the aforementioned aspects. The portal application also allows service and connection pricing to reflect these aspects. The portal application allows users and customers to define their offerings via various attributes, such as QoS, product or service offerings, service type, etc., which are visible to others who may be seeking services or connections. According to various aspects, the portal application is capable of facilitating selling, leasing, establishing, managing, auditing, quantifying, and analyzing connectivity and associated relationships between users, networks and service providers.

These and other aspects will become readily apparent from the written specification, drawings, and claims provided herein.

### BRIEF DESCRIPTION OF DRAWINGS

FIG. 1 is a schematic diagram of an exemplary system framework for purposes of illustrating one or more aspects described herein.

FIG. 2 is a schematic diagram of an exemplary central network connection configuration between a plurality of network edge locations for purposes of illustrating one or more aspects described herein.

FIGS. 3A-3D are schematic diagrams illustrating exemplary edge location configurations according to one or more aspects described herein.

FIG. 4 is a schematic diagram of an exemplary network configuration in connection with application services for purposes of illustrating one or more aspects described herein.

FIG. 5 is a schematic diagram of an exemplary embodiment for use of the central network in accordance with one or more aspects described herein.

FIGS. 6A-6I are exemplary illustrations of screenshots associated with an exemplary embodiment of a portal in accordance with on ore more aspects described herein.

FIG. 7 is a flowchart of an exemplary process according to one or more aspects described herein.

### DETAILED DESCRIPTION OF EXEMPLARY EMBODIMENTS

The description that follows describes, illustrates and exemplifies one or more particular embodiments of the invention(s) in accordance with its principles. This description is not provided to limit the invention(s) to the embodiments described herein, but rather to explain and teach the principles of the invention(s) in such a way to enable one of ordinary skill in the art to understand these principles and, with that understanding, be able to apply them to practice not only the embodiments described herein, but also other embodiments that may come to mind in accordance with these principles. The scope of the invention(s) is intended to cover all such embodiments that may fall within the scope of the appended claims, either literally or under the doctrine of equivalents.

It should be noted that in the description and drawings, like or substantially similar elements may be labeled with the same reference numerals. However, sometimes these elements may be labeled with differing numbers, such as, for example, in cases where such labeling facilitates a more clear description. Additionally, the drawings set forth herein are not necessarily drawn to scale, and in some instances proportions may have been exaggerated to more clearly depict certain features. Such labeling and drawing practices do not necessarily implicate an underlying substantive purpose. As stated above, the present specification is intended to be taken as a whole and interpreted in accordance with the principles of the invention(s) as taught herein and understood to one of ordinary skill in the art.

With respect to the exemplary systems, components and architecture described and illustrated herein, it should also be understood that the invention(s) may be embodied by, or employed in, numerous configurations and components, including one or more system, hardware, software, or firmware configurations or components, or any combination thereof, as understood by one of ordinary skill in the art. Accordingly, while the drawings illustrate exemplary systems including components for one or more of the embodiments contemplated herein, it should be understood that with respect to each embodiment, one or more components may not be present or necessary in the system. Accordingly, the invention(s) should not be construed as limited by the exemplary embodiments described herein or any of the associated didactic schematics.

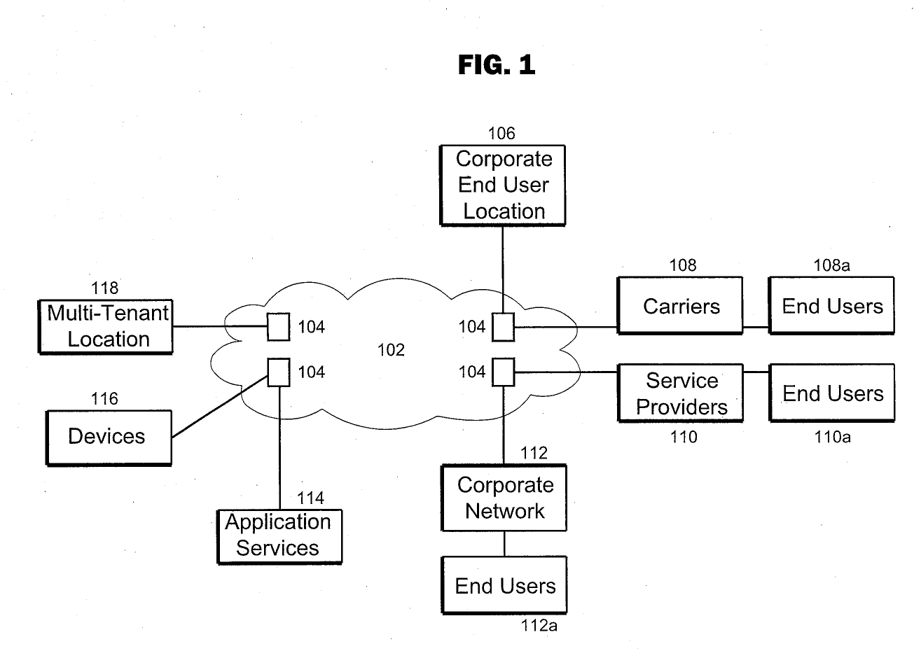

FIG. 1 is a high-level schematic diagram illustrating an exemplary system framework 100 within which one or more principles of the invention(s) may be employed. The system framework 100 includes a central service network 102 including a plurality of edge connection points 104 in communication with each other via the network and each either in communication with or capable of communicating with at least one of a plurality of external elements, which may include, for example, a corporate end user location 106, a telecommunications carrier 108 serving end users 108a, a service provider 110 serving end users 110a, a corporate network 112 serving end users 112a, application services 114, devices 116, or a multi-tenant location 118. It is contemplated that any type of service, network, device, application, or other functionality to which a user of a network may seek connection to, or control or use thereof, can be incorporated into the framework 100. As will be described in more detail below, aspects of the systems and methods can be used for managing interconnection and service aspects amongst a plurality of external elements, such as the exemplary external elements described above. However, further description of the exemplary framework 100 and exemplary architecture will be helpful in understanding these aspects.

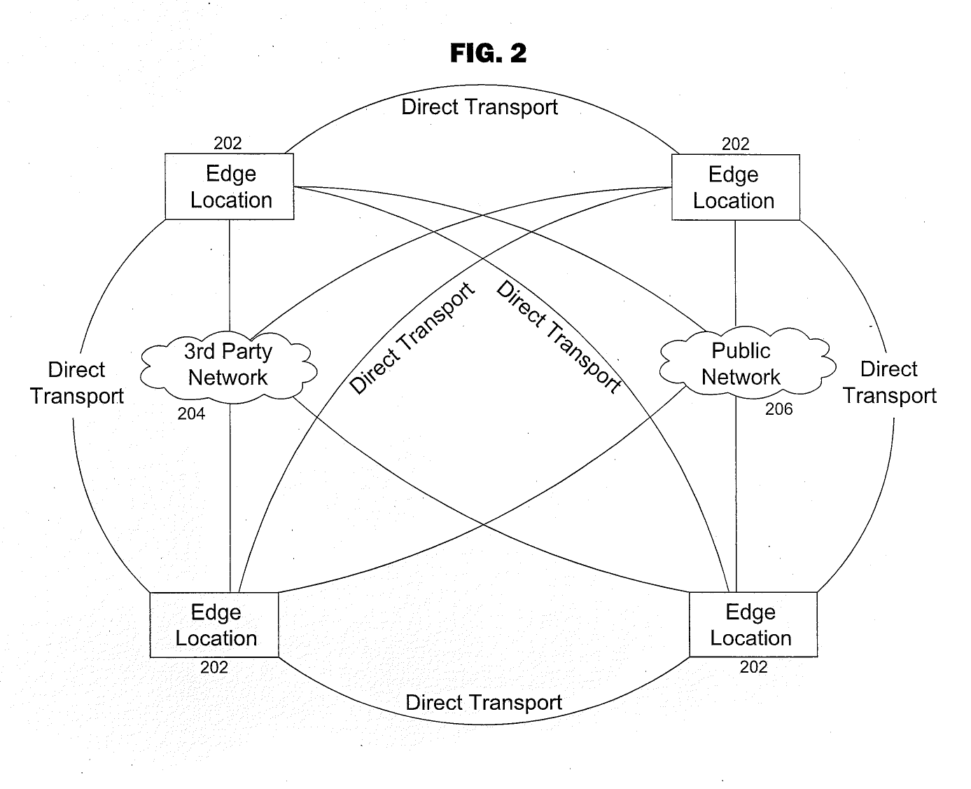

FIG. 2 illustrates exemplary connectivity and transport between edge locations 202 within a central service network, such as central service network 102. As shown in FIG. 2, connectivity between each of the edge locations 202 may be via direct transport to one or more of the other edge locations 202, or it may also involve connection through one or more networks such as a third-party network 204 or a public network 206, such as the Internet. Each of these edge locations 202 connects to and communicates with an external element, such as, for example, any of the elements described above. Thus, by way of example, and in furtherance of one or more aspects of the subject systems and methods, the central service network facilitates connections, such as a data or telecommunications service connection, that a user may desire to a particular location outside the user's existing system or network. As will become apparent from further description herein, it is contemplated that when connectivity is established for such a user, that user's existing system or network will become part of the central service network's capability and reach through, for example, E-NNIs (external network-to-network interfaces), and will be visible to other users who may desire connectivity to that particular user's system or network.

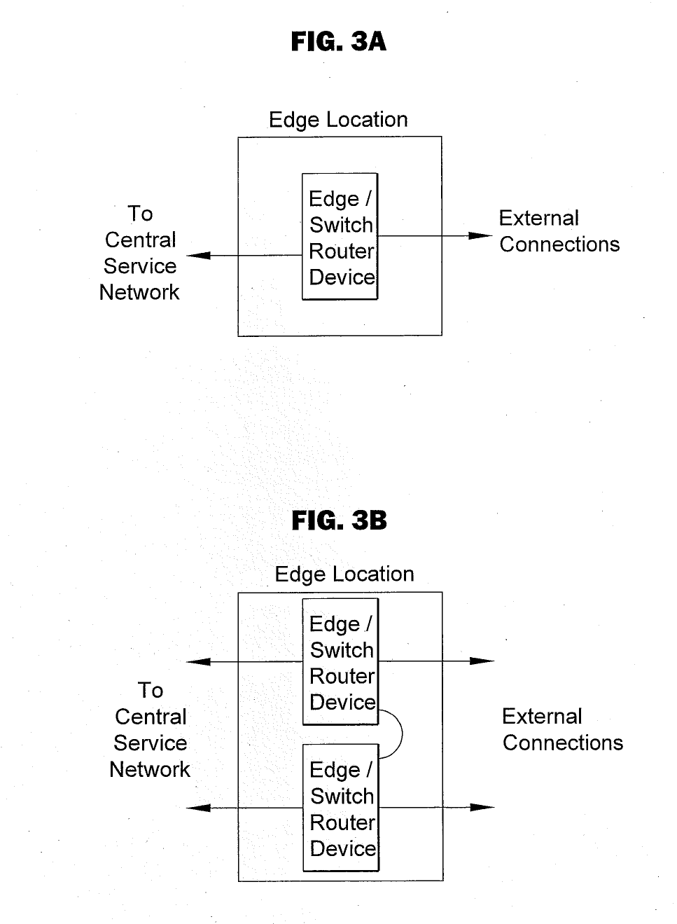

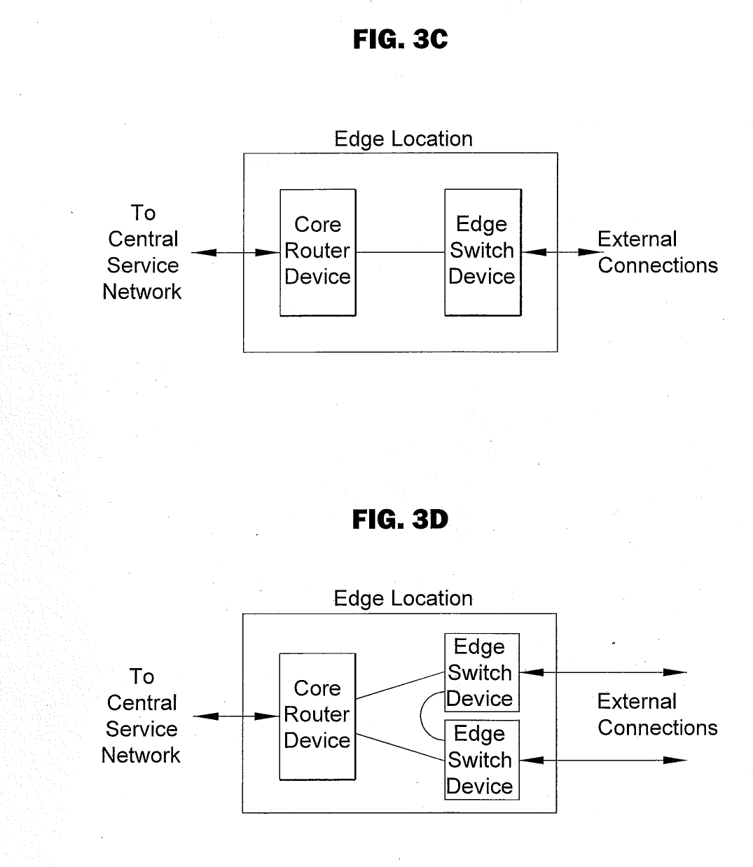

For further context of exemplary architecture with respect to the edge locations, FIGS. 3A-3D illustrate various edge location configurations that may be employed to provide connectivity to external elements with the understanding that any number of configurations known in the art may be employed. As shown in FIG. 3A, an edge location may be configured as a single edge switch/router device, wherein the edge switch/router device is in communication with the central service network and is capable of or in communication with one or more external elements, thereby providing external connections for the benefit of the users of the central service network. As shown in FIG. 3B, an edge location may be configured with two or more edge switches/router devices primarily for redundancy. In this configuration, each edge switch/router device is in communication with the central service network and is capable of or in communication with one or more external elements. The edge switches/router devices are also in communication with each other. As shown in FIG. 3C, an edge location may be configured with a core router device separate from and in communication with an edge switch device. As shown in FIG. 3D, an edge location may be configured with a core router device separate from and in communication with two or more edge switch devices for redundancy. In a particular implementation, the central service network is an Ethernet network which employs one or more Ethernet switches, which is preferably a multi-port switch module or an array of modules. The Ethernet switch may be, merely by way of example, one or more components from the 6500 Catalyst Series from Cisco Systems, Inc., which may include one or more supervisors, chassis configurations, modules, PC cards, as well as operating system software.

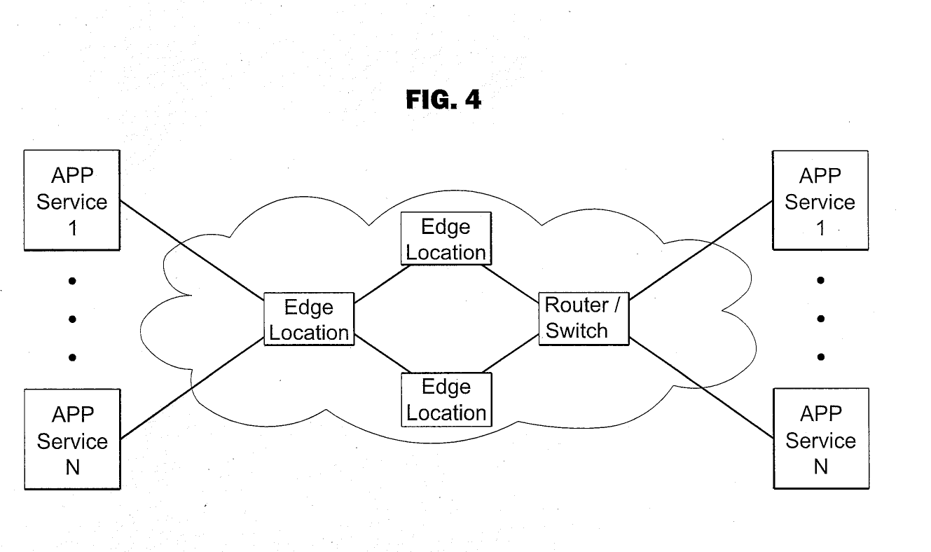

As previously mentioned, the central service network may provide connectivity to any number of external elements, including a plurality of application services. Such connectivity may be employed in any number of ways as known in the art. As shown in FIG. 4, one or more application services may be accessible to a user via one or more edge location connections. Furthermore, one or more application services may be accessible within the central service network and connectable via a router/switch within the network. It is contemplated that one or more application services may be hosted by the central service network for the benefit of network users.

As previously mentioned, according to a particular aspect, a system for managing interconnection and service aspects amongst a plurality of external elements in communication or capable of communication with the central service network is contemplated. The system includes the aforementioned central service network, which includes a plurality of edge connection points in communication with each other and each either in communication with or capable of communicating with at least one of the plurality of external elements. The system further includes a server in communication with the central service network, which hosts a portal application accessible to manage interconnection and service aspects amongst the plurality of external elements. In an embodiment, the portal application has visibility of the edge connection points and connected external elements to determine interconnection and service aspects for one or more selected external elements. By way of example, the manageability of interconnection and service aspects may include the immediate identification of connectability to the selected external elements, quality of service (QoS), service offerings, capabilities, connection type, or statistics for the selected external elements.

In an embodiment, the portal application (a) allows at least one client or user to access information relating to connectability and service characteristics of the plurality of external elements, (b) has visibility of the edge connection points and connected external elements to determine connectability between the plurality of external elements, and (c) allows the at least one client or user to request connection to a selected one or more of the plurality of external elements.

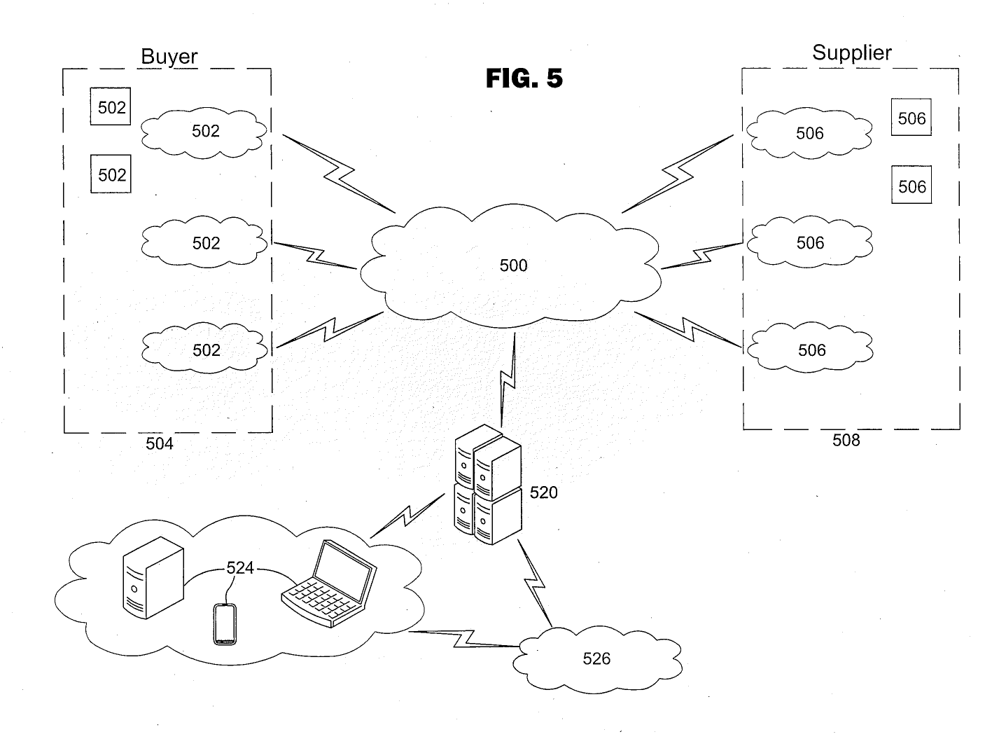

FIG. 5 illustrates an embodiment for purposes of exemplifying one or more of the aforementioned management aspects. Referring to FIG. 5, a central service network 500 provides capability to connect elements 502 of a first network 504 (which may include one or more other networks) and one or more elements 506 of a second network 508 (which may also include one or more other networks). In an exemplary application, one or more elements 502 of the network 504 may be associated with buyers of network connectivity and one or more elements 506 of the network 508 may be associated with suppliers or sellers of network connectivity. A buyer associated with one or more clients or networks within the network 504 may desire to obtain a connection with one or more networks or clients within the network 508. A supplier associated with one or more networks or clients within the plurality of networks may be willing to supply the desired access. According to a particular aspect, a service provider associated with the central service network may provide connectivity service to facilitate connectivity transactions and management between the buyer and the supplier.

Referring again to FIG. 5, a system, computer or server 520 provides a portal application associated with, or capable of communicating with, the central service network. The portal application provides functionality in connection with the connectivity, relationships and behaviors between the buyer and the supplier. The buyer may access the portal via a client device 524, such as a computer, or over a network 526, such as the Internet. It should be noted that while a portal application operating on a server is described herein, other implementations to provide such functionality are possible and considered within the scope of this aspect.

While depicted schematically as a single server, computer or system, it should be understood that the term “server” as used herein and as depicted schematically herein may represent more than one server or computer within a single system or across a plurality of systems, or other types of processor based computers or systems. The server 520 includes at least one processor, which is a hardware device for executing software/code, particularly software stored in a memory or stored in or carried by any other computer readable medium. The processor can be any custom made or commercially available processor, a central processing unit (CPU), an auxiliary processor among several processors associated with the server 520, a semiconductor based microprocessor (in the form of a microchip or chip set), another type of microprocessor, or generally any device for executing software code/instructions. The processor may also represent a distributed processing architecture.

The server operates with associated memory and can include any one or a combination of volatile memory elements (e.g., random access memory (RAM, such as DRAM, SRAM, SDRAM, etc.)) and nonvolatile memory elements (e.g., ROM, hard drive, tape, CDROM, etc.). Moreover, memory may incorporate electronic, magnetic, optical, and/or other types of storage media. Memory can have a distributed architecture where various components are situated remote from one another, but are still accessed by the processor.

The software in memory or any other computer readable medium may include one or more separate programs. The separate programs comprise ordered listings of executable instructions or code, which may include one or more code segments or portions, for implementing logical functions. In the exemplary embodiments herein, a server application or other application runs on a suitable operating system (O/S). The operating system essentially controls the execution of the portal application, or any other computer programs of server 520, and provides scheduling, input-output control, file and data management, memory management, and communication control and related services.

In the context of this document, a “computer-readable medium” may be any means that can store, communicate, propagate, or transport data objects for use by or in connection with the server 520 or any other system component. The computer readable medium may be for example, an electronic, magnetic, optical, electromagnetic, infrared, or semiconductor system, apparatus, device, propagation medium, or any other device with similar functionality. More specific examples (a non-exhaustive list) of the computer-readable medium would include the following: an electrical connection (electronic) having one or more wires, a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and stored in a computer memory. The software and/or other functional aspects of the portal application or system can be embodied in any type of computer-readable medium for use by or in connection with an instruction execution system or apparatus, such as a computer, such as the server 520.

The portal concept can be used to facilitate all aspects of functionality related to the central service network, including providing users, customers and potential subscribers the ability to manage the selection, connection and provisioning of services, such as application services or data or voice connection services, based on various criteria, such as connectability to selected external elements, quality of service (QoS), service offerings, connection type, or statistics for the selected external elements. The portal application also allows service and connection pricing to reflect these aspects. Furthermore, the portal application allows users and customers to define their offerings via various attributes, such as QoS, product or service offerings, service type, etc., which are visible to others who may be seeking services or connections. The portal application provides a platform for facilitating selling, leasing, establishing, managing, auditing, quantifying, and analyzing connectivity and associated relationships between users, networks and service providers. The portal application has visibility of the edge connection points and connected external elements to determine interconnection and service aspects for one or more selected external elements.

According to a particular aspect, the portal is useful in providing functionality for managing connectivity, relationships and behaviors between buyers and supplier network(s). Such functionality can be implemented via one or more server applications or other software associated with the server 520. According to a particular aspect, the portal may provide a buyer with functionality relating to placing an order for one or more connections and checking availability of connections. For example, the buyer may be able to check for lists of suppliers, capacity of suppliers, types of service, and lead time to implement connections. As part of the service, it is contemplated that users of the portal may be able to (1) manage orders between buyers and suppliers; (2) manage and simplify Letters of Authorization (LOA) and Connecting Facility Assignment (CFA), and manage intercarrier trust levels; and (3) manage various aspects of the service.

Management of orders may include managing capacity, notifying suppliers of connectivity and relationships, confirmations of connectivity and relationships, and providing Design Layout Records (DLR), which represents the detailed design path of a completed telecommunications circuit, including all facilities from one end of the circuit to the other end.

The portal provides simplification of the LOA process. An LOA is a document that indicates if a Carrier or CLEC/Reseller is acting as an end user's agent. This Authorization needs to be kept on file with the Carrier or CLEC/Reseller. The portal functionality can automate one or more aspects of the LOA process and management.

According to another aspect, the portal can be used to automate the Connecting Facility Assignment (CFA). For example, assignment can be automatic based on one or more algorithms, such as, for example, matching characteristics of buyer service or network to supplier service or network. The automation may also include management of mapping configurations for channels/connections.

According to another aspect, the portal can be used to facilitate management of service by a user, such as, for example, management of configuration changes and reporting regarding service, billing, ordering status, inventory, and performance metrics. With respect to performance metrics, a user can check and manage service or network stats, relating to either the switch service provider portion or end to end from buyer to supplier.

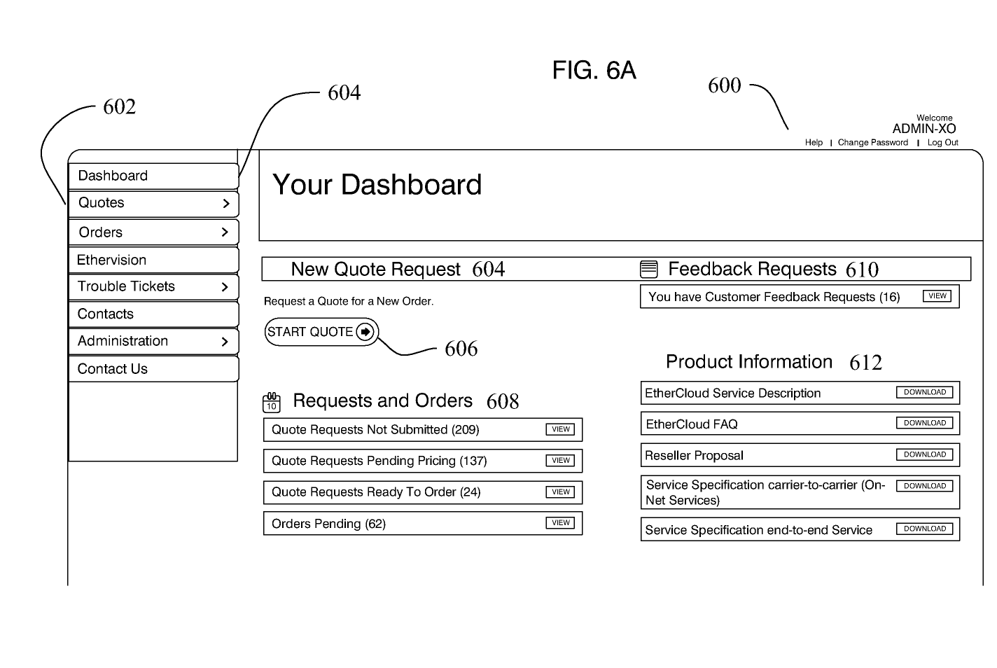

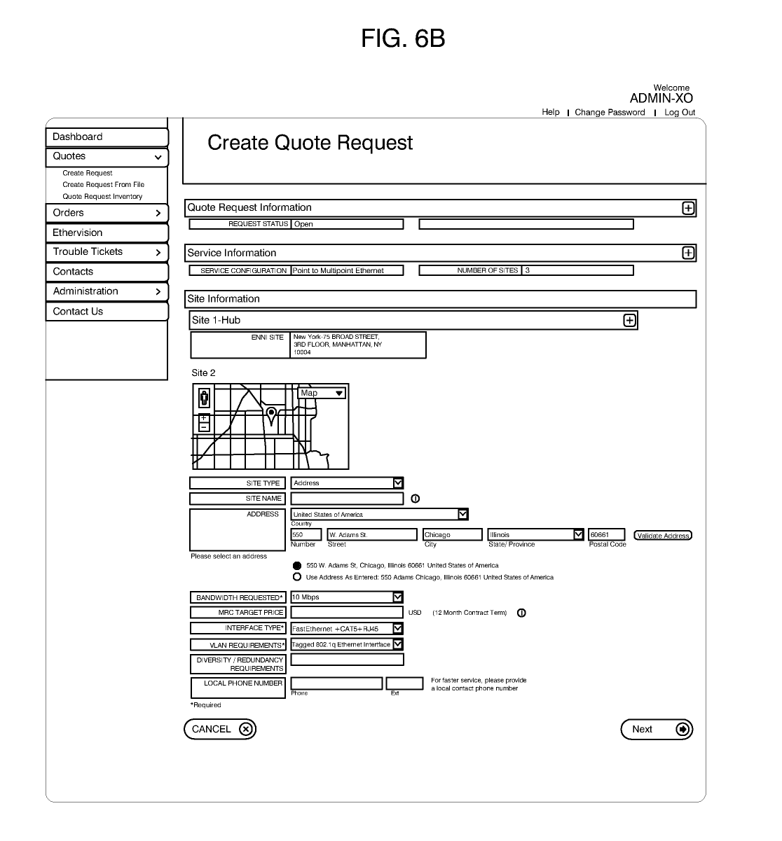

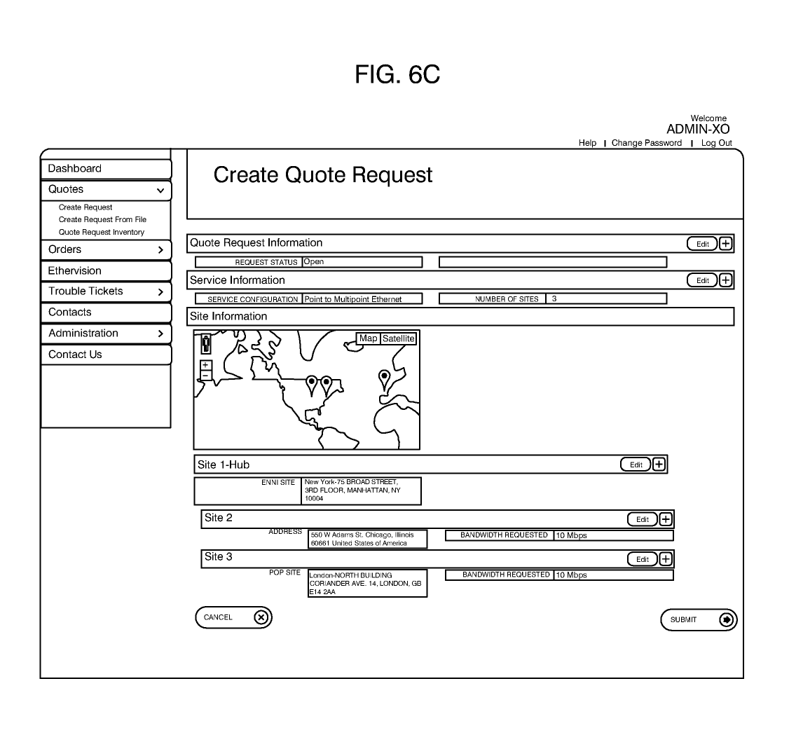

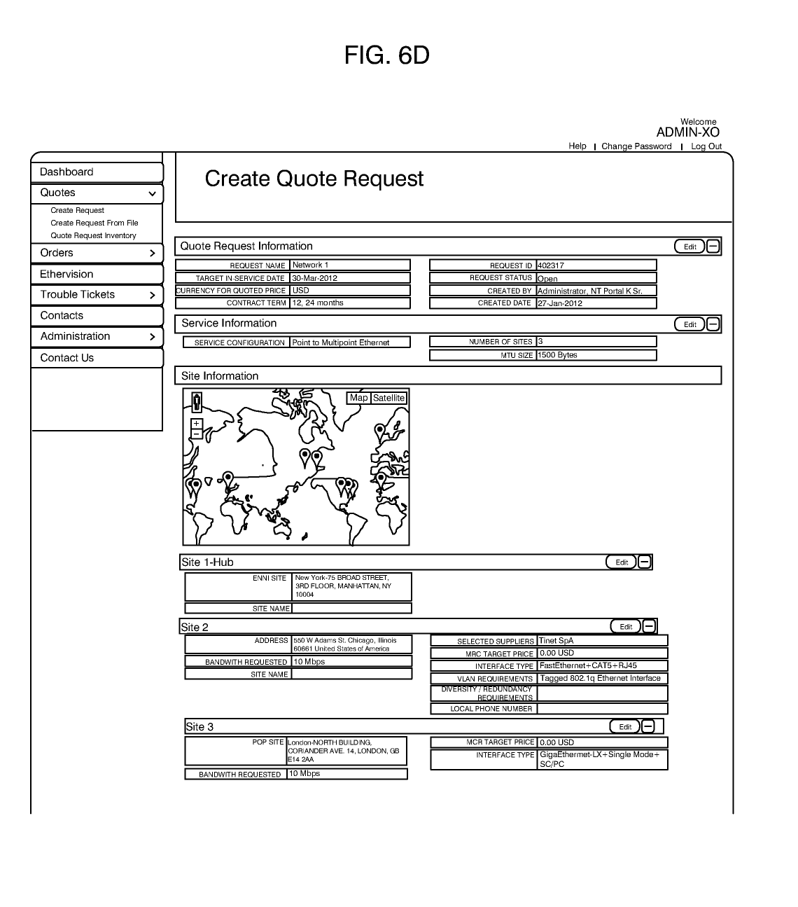

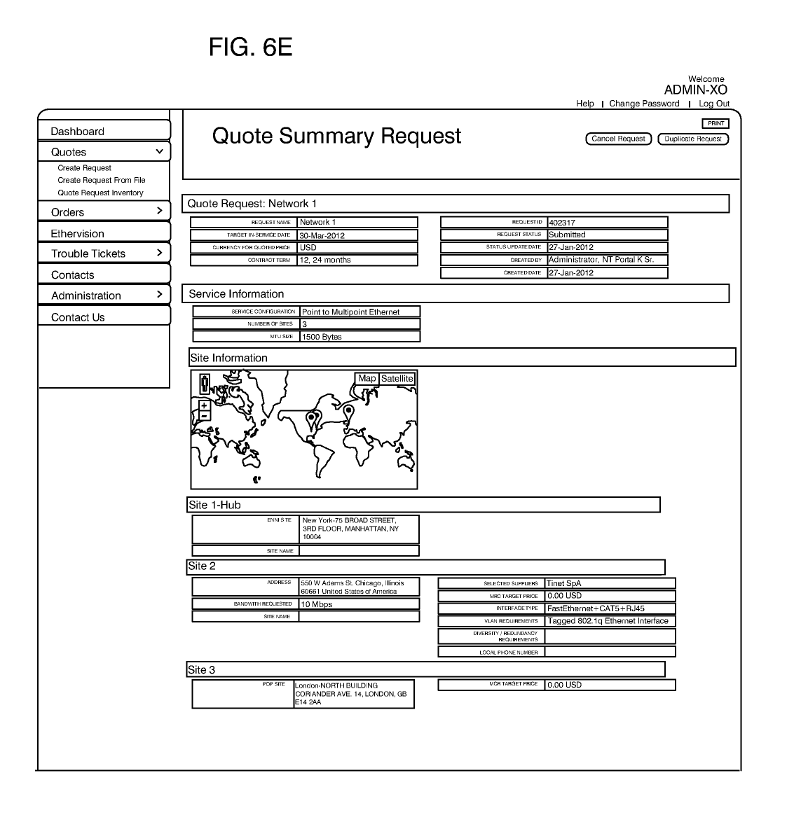

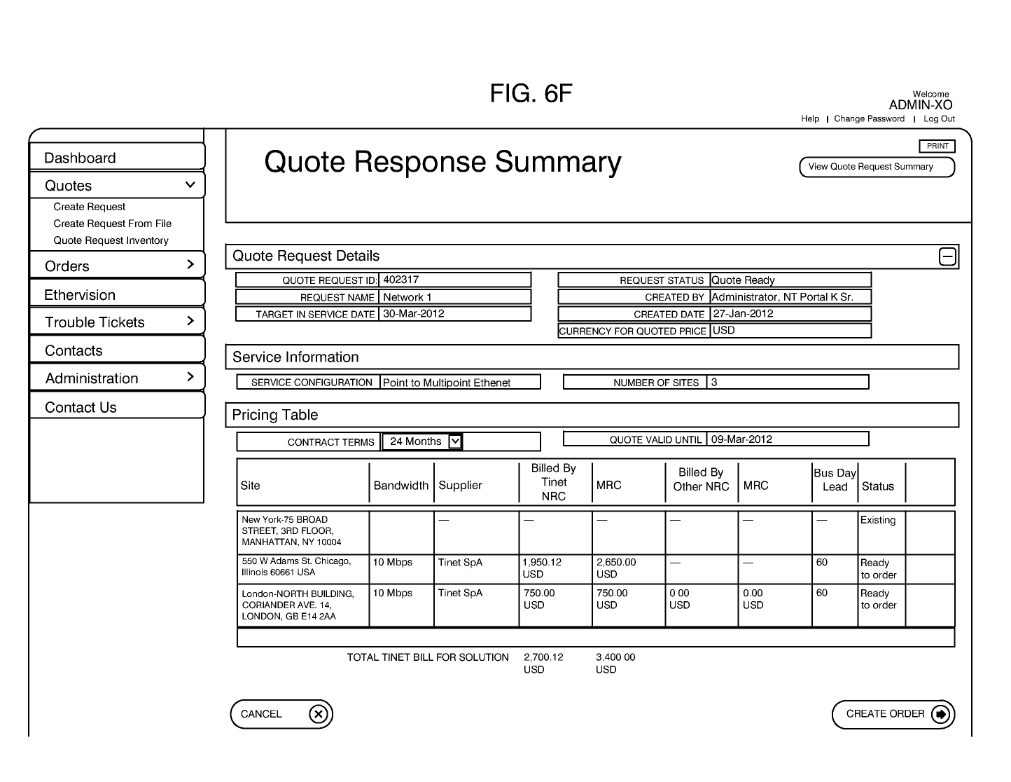

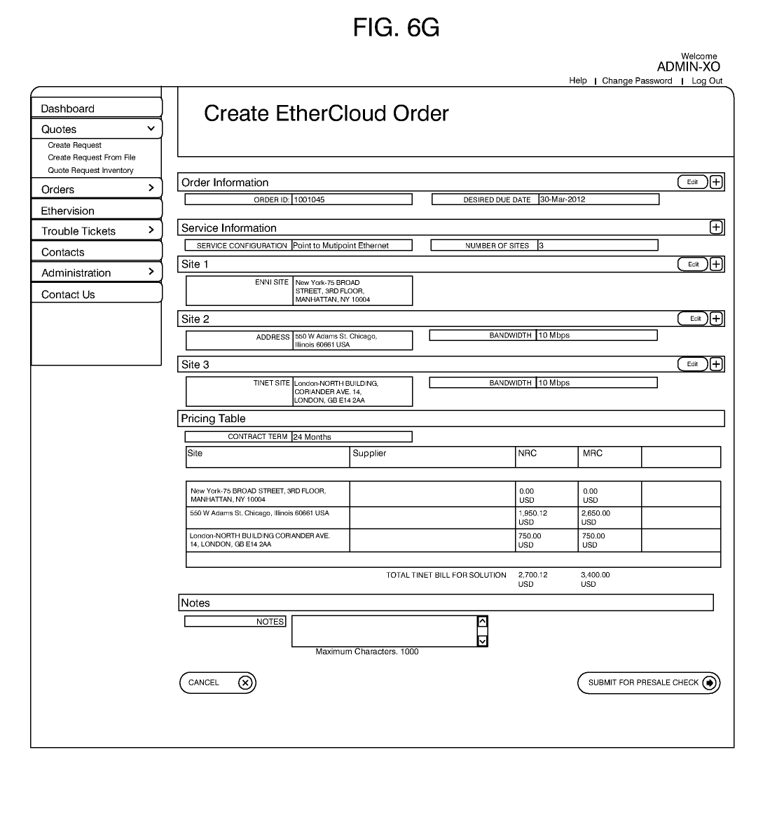

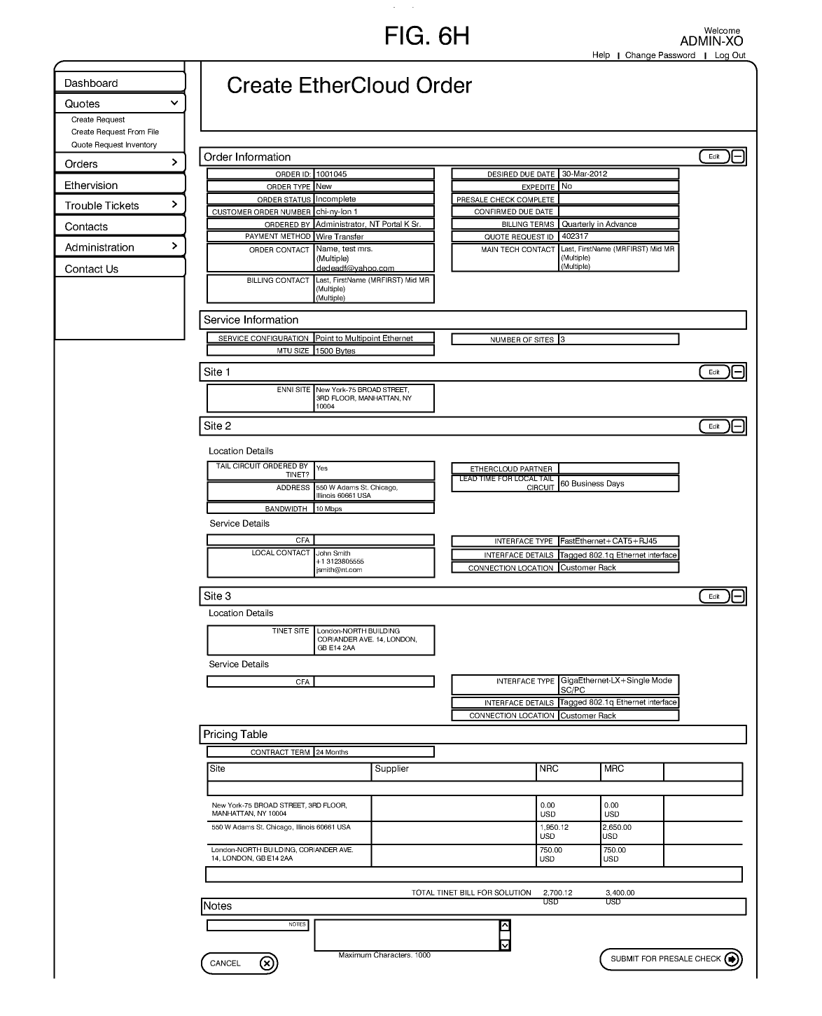

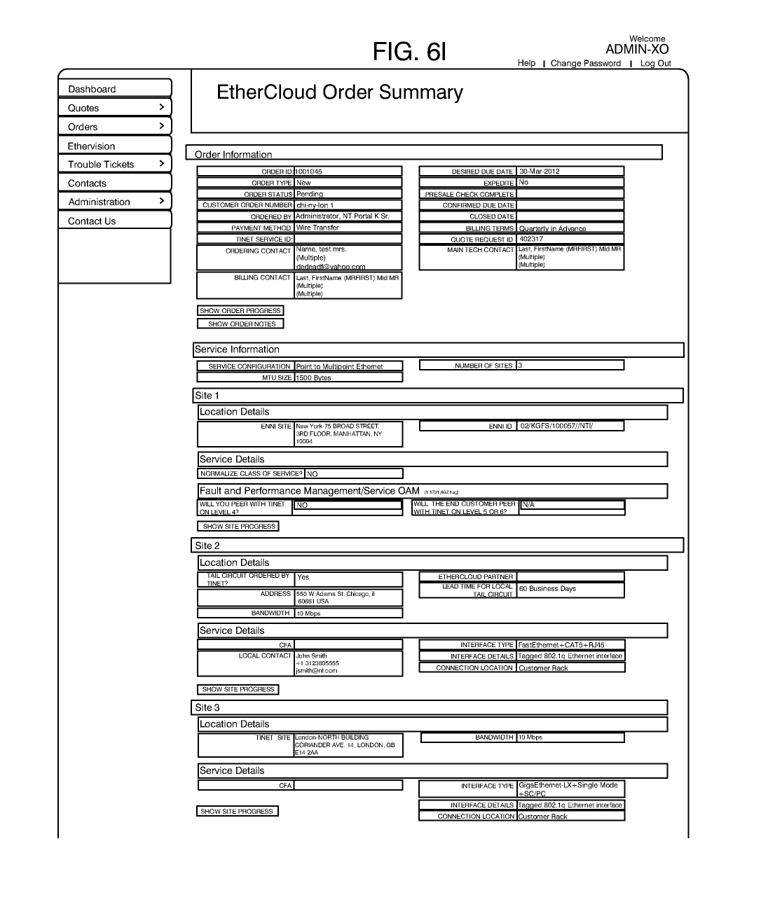

FIGS. 6A-6I are a collective set of exemplary screenshots of an embodiment of the portal GUI. Referring generally to FIG. 6A, a customer of connectivity services can access the portal and is presented with a plurality of options and functions in general user interface screen 600 in accordance with the aforementioned aspects of the portal and associated system and methods. As shown in FIG. 6A, a customer may be presented with a plurality of portal options 602 along the left-hand side of the screen. FIG. 6A illustrates an exemplary “dashboard” option 604, which provides functionality for customers to start a new quote request for a new order at 606, view and manage all customer requests based on status at 608, view and respond to feedback requests at 610, and access product information at 612.

When a customer elects to start a new quote request at 606, they may be presented with a first associated screen to create a quote request as exemplified in FIG. 6B. The customer may be presented with various data fields associated with the request, such as, for example, request status, service configuration, site information, bandwidth requested, interface type VLAN requirements, and any other information needed or desired in connection with fulfilling the service request. In the illustrated example, Site 1 is the hub of a three site connection configuration which is being requested in this example and will be illustrated in the remaining screenshots of FIGS. 6C-6I. An optional map function may be provided to assist with determining site locations.

As the customer progresses through the request as illustrated in FIGS. 6A-6E, they can enter information relating to the remaining sites and other service-related information. In this example, information relating to three sites is entered, with functional options, for example, to edit or add additional information. The customer may be presented with additional queries for information relating to the desired connectivity configuration amongst the sites. When the information for the request is entered, the customer may submit the request, which is processed by the system to generate a quote for the requested service connectivity configuration and which, in an embodiment, results in a quote response summary such as that illustrated in FIG. 6F. The customer may then elect to proceed with creating the order, upon which the customer may be presented with the screens illustrated in FIGS. 6G and 6H. Upon submission of an order, the customer may be presented with an order summary screen, such as the exemplary screen illustrated in FIG. 6I.

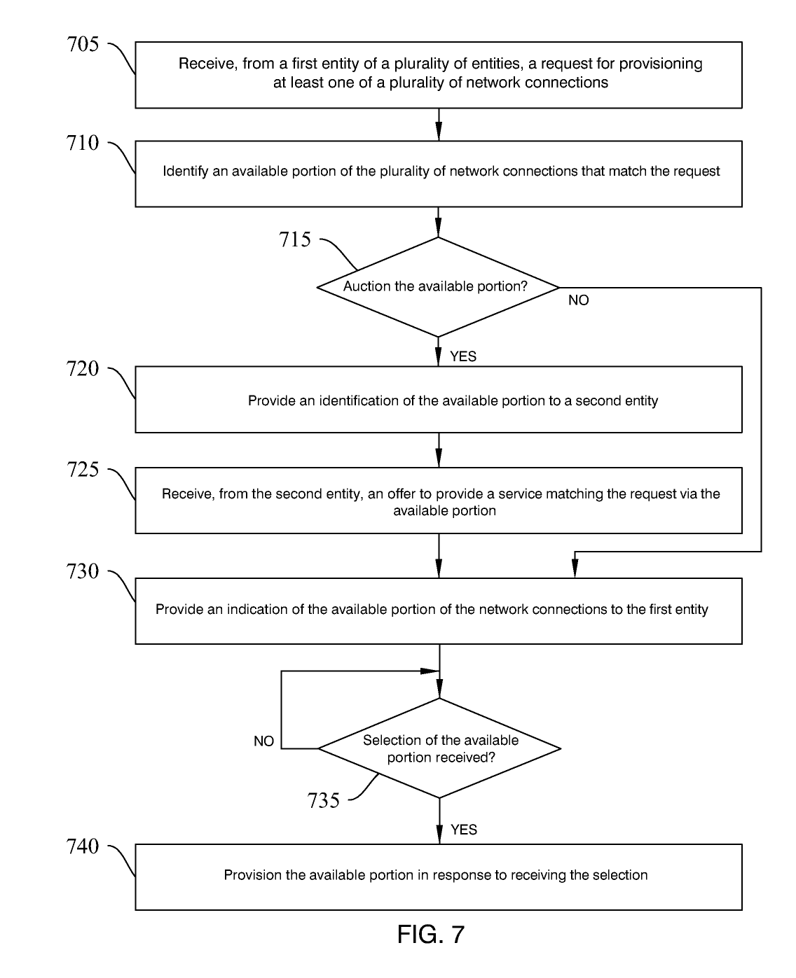

FIG. 7 is a flowchart of a method for an electronic device (such as the system, computer or server 520 as discussed with respect to FIG. 5) to facilitate a provisioning of various network connections. More particularly, the method relates to brokering a provisioning request between a buyer and a supplier.

The method begins with the electronic device receiving 705, from a first entity of a plurality of entities, a request for provisioning at least one of a plurality of network connections. According to aspects, the first entity can be a buyer and the request can include an identification of at least one of a connection type, a service offering, or a quality of service (QoS). The electronic device identifies 710 an available portion of the plurality of network connections that matches the request. For example, the available portion can have a capability that matches a desired capability indicated by the request. The electronic device determines 715 whether to auction the available portion. Particularly, the electronic device can determine to auction the available portion if there is not an available supplier to fulfill the request.

If the electronic device determines not to auction the available portion (“NO”), for example if a supplier is already associated with the available portion, the processing can proceed to 730. In contrast, if the electronic device determines to auction the available portion (“YES”), the electronic device provides 820 an identification of the available portion to a second entity. For example, the electronic device can list specifications associated with the available portion. The electronic device receives 725, from the second entity, an offer to provide a service matching the request via the available portion.

The electronic device provides 730 an indication of the available portion of the network connections to the first entity. The electronic device determines 735 if a selection of the available portion is received. Particularly, the electronic device determines whether the first entity has selected to proceed with the provisioning. If the selection is received (“YES”), the electronic device provisions 740 the available portion in response to receiving the selection. The provisioning is facilitated according to the request and based on any agreements between the buyer and the supplier.

While one or more specific embodiments have been illustrated and described in connection with the invention(s), it is understood that the invention(s) should not be limited to any single embodiment, but rather construed in breadth and scope in accordance with recitation of the appended claims.

What is claimed is:

1. A system for managing interconnection and service aspects amongst a plurality of external elements, the system comprising:
a central service network comprising a plurality of edge connection points either in communication or capable of communicating with each other and each either in communication with or capable of communicating with at least one of the plurality of external elements; and
a server in communication with the central service network and hosting a portal application accessible to manage interconnection and service aspects amongst the plurality of external elements, the portal application having visibility of the edge connection points and connected external elements to determine interconnection and service aspects for a selected at least one of the plurality of external elements.

2. The system of claim 1, wherein each of the plurality of external elements is selected from the group consisting of a corporate network, a service provider network, a carrier network, an application service server, a device, a corporate end user location, or a multi-tenant location.

3. The system of claim 1, wherein the determination of interconnection and service aspects comprises immediate identification of connectability to the selected at least one of the plurality of external elements.

4. The system of claim 1, wherein the determination of interconnection and service aspects comprises immediate identification of capability of the selected at least one of the plurality of external elements.

5. The system of claim 1, wherein the determination of manageability of interconnection and service aspects comprises identification of quality of service (QoS) for the selected at least one of the plurality of external elements.

6. The system of claim 1, wherein the determination of manageability of interconnection and service aspects comprises identification of service offerings for the selected at least one of the plurality of external elements.

7. The system of claim 1, wherein the determination of manageability of interconnection and service aspects comprises identification of connection type for the selected at least one of the plurality of external elements.

8. The system of claim 1, wherein the determination of manageability of interconnection and service aspects comprises identification of performance statistics for the selected at least one of the plurality of external elements.

9. The system of claim 1, wherein the server hosting the portal is within the central service network.

10. The system of claim 1, the central service network further comprising an element manager in communication with each of the plurality of edge connections and the server hosting the portal application.

11. The system of claim 1, the central service network further comprising at least one server in communication with at least one of the plurality of edge connections and hosting a service application.

12. The system of claim 1, the central service network further comprising at least one router or switch device in communication with at least one edge connection and a server in communication with either one of the switch device or the router and hosting a service application.

13. The system of claim 1, wherein at least one edge connection point comprises an edge switch router device capable of communicating with the at least one of the plurality of external elements.

14. The system of claim 1, wherein at least one edge connection point comprises a pair of edge switch routing devices connected to each other for redundancy and each capable of communicating with the at least one of the plurality of external elements.

15. The system of claim 1, wherein at least one edge connection point comprises an edge switch device connected to a router device, the edge switch device capable of communicating with the at least one of the plurality of external elements.

16. The system of claim 1, wherein at least one edge connection point comprises a pair of edge switch routing devices connected to each other for redundancy and each connected to a router device, each of the edge switch routing devices capable of communicating with the at least one of the plurality of external elements.

17. The system of claim 1, wherein the plurality of edge connection points are in communication with each other via a connection mode selected from the group consisting of a direct transport, a public network, and a third party network connection service.

18. The system of claim 17, wherein the direct transport comprises a fiber connection.

19. The system of claim 17, wherein the direct transport comprises an Ethernet connection.

20. The system of claim 17, wherein the public network comprises the Internet.

21. The system of claim 17, wherein the public network comprises a VPN across the Internet.

22. The system of claim 16, wherein the third party network service comprises an MPLS service.

23. A computer program product stored on a non-transitory computer-readable medium, the computer program product having computer-executable code instructions which are executable on a computer server to manage interconnection and service aspects amongst a plurality of external elements either connected or connectable to a central service network comprising a plurality of edge connection points either in communication with or capable of communicating with each other and each either in communication with or capable of communicating with at least one of the plurality of external elements, the computer-executable code instructions comprising:
first code instructions for receiving a request from a client for connection between one of the plurality of external elements and at least one of the other of the plurality of external elements;
second code instructions for determining connectability to the at least one of the other of the plurality of external elements by checking visibility of the edge connection points and connected external elements; and
third code instructions for establishing the connection if the at least one of the other of the plurality of external elements is either connected or connectable based on checking visibility of the edge connection points and connected external elements.

24. The computer program product of claim 23, further comprising:
fourth code instructions for identifying to the client quality of service (QoS) of the at least one of the other of the plurality of external elements.

25. The computer program product of claim 23, further comprising:
fourth code instructions for identifying to the client service offerings for the at least one of the other of the plurality of external elements.

26. The computer program product of claim 23, further comprising:
fourth code instructions for identifying connection type for the at least one of the other of the plurality of external elements.

27. The computer program product of claim 23, further comprising:
fourth code instructions for identifying statistics for the at least one of the other of the plurality of external elements.

28. A system for managing interconnection and service aspects amongst a plurality of external elements, the system comprising:
a central service network comprising a plurality of edge connection points in communication with or capable of communicating with each other and each either in communication with or capable of communicating with at least one of the plurality of external elements; and
a server in communication with the central service network and hosting a portal application accessible by at least one client to manage interconnection and service aspects amongst the plurality of external elements, the portal application (a) allowing the at least one client to access information relating to connectability and service characteristics of the plurality of external elements, (b) having visibility of the edge connection points and connected external elements to determine connectability between the plurality of external elements, and (c) allowing the at least one client to request connection to a selected one or more of the plurality of external elements.

29. The system of claim 28, wherein each of the plurality of external elements is selected from the group consisting of a corporate network, a service provider network, a carrier network, an application service server, a device, a corporate end user location, or a multi-tenant location.

30. The system of claim 28, wherein the plurality of edge connection points are in communication with each other via a connection mode selected from the group consisting of a direct transport, a public network, and a third party network connection service.

31. The system of claim 28, wherein the service characteristics of the plurality of external elements comprise price of service.

32. The system of claim 28, wherein the service characteristics of the plurality of external elements comprise quality of service (QoS).

33. The system of claim 28, wherein the service characteristics of the plurality of external elements comprise performance metrics.

34. The system of claim 33, wherein the performance metrics comprise latency.

35. The system of claim 33, wherein the performance characteristics comprise dropped packet statistics.

36. A system for managing service configurations among a plurality of entities, the system comprising:
a central service network comprising network connections accessible by the plurality of entities; and
a server in communication with or capable of communicating with the central service network and hosting a portal application configured to:
receive, from a first entity of the plurality of entities, a request for provisioning at least one of the network connections,
identify an available portion of the network connections that matches the request, and
provision the available portion of the network connections according to the request.

37. The system of claim 36, wherein the portal application is further configured to:
receive, from a second entity of the plurality of entities, an offer to provide a service via an additional portion of the network connections.

38. The system of claim 36, wherein the request indicates a desired capability, and wherein the identifying the available portion of the network connections that matches the request comprises:
identifying the available portion having a capability that matches the desired capability.

39. The system of claim 36 wherein the provisioning the available portion of the network connections according to the request comprises:
provide an indication of the available portion of the network connections to the first entity,
receive, from the first entity, a selection of the available portion of the network connections, and
provisioning the available portion in response to the receiving the selection.

40. The system of claim 36, wherein the request comprises an identification of at least one of a connection type, a service offering, or a quality of service (QoS).

41. The system of claim 40, wherein the provisioning the available portion of the network connections according to the request comprises:
provisioning the available portion according to the at least one of the connection type, the service offering, or the quality of service (QoS).

42. The system of claim 36, wherein the identifying the available portion of the network connections that matches the request comprises: (reverse auction)
identifying the available portion that fulfills a capability specified by the request,
providing an identification of the available portion to a second entity, and
receiving, from the second entity, an offer to provide a service matching the request via the available portion.

43. The system of claim 36, where the provisioning the available portion of the network connections according to the request comprises:
activating the available portion for use by the first entity of a service of a second entity.

44. The system of claim 36, wherein the identifying the available portion of the network connections that matches the request comprises:
identifying a lead time needed to implement connectivity to the available portion, and
providing an indication of the lead time to the first entity.
